(19) United States
(12) Patent Application Publication
(10) Pub. No.: US 2017/0161679 A1
(43) Pub. Date: Jun. 8, 2017

(54) Package Tracking Device and Method

(71) Applicant: ShadowTrack 247, LLC, Fletcher, NC (US)

(72) Inventors: Jeffrey W. Stingel, Asheville, NC (US); Justin Cohan, Lake Park, FL (US); Steven Taveau, Royse City, TX (US)

(73) Assignee: ShadowTrack 247, LLC, Fletcher, NC (US)

(21) Appl. No.: 15/367,827

(22) Filed: Dec. 2, 2016

Related U.S. Application Data
(60) Provisional application No. 62/262,997, filed on Dec. 4, 2015.

(51) Int. Cl. G06Q 10/08; G01S 19/14

(52) U.S. Cl. CPC G06Q 10/0833; G01S 19/14

(57) ABSTRACT

A method for tracking cargo for a customer includes the steps of providing a tracking device to the customer, wherein the tracking device includes at least one data signaling device, a battery coupled to the at least one data signaling device for powering the at least one data signaling device, and a container surrounding a cavity, the container being sized and configured for securing the at least one data signaling device and the battery therein, and the container including a prepaid shipping label on an outer surface; providing an electronic application to the customer, the electronic application being in communication with the at least one data signaling device for monitoring the location of the tracking device, and the electronic application being configured for storing and displaying a plurality of data points relating to the tracking device; notifying the customer when one or more of the plurality of data points is equal to a preselected value; and receiving the tracking device from the customer.

### FIELD OF THE INVENTION

This invention relates to parcel tracking between two or more entities and, more particularly, to a device for tracking, visualizing and documenting the location of associated cargo and unilaterally delivering related information to shippers, intended recipients and/or authorized third-parties upon the occurrence of one or more events.

### BACKGROUND OF THE INVENTION

Package tracking is an integral part of a parcel delivery service that allows a customer to track goods that they have shipped or that have been shipped to them. Historically, organizations could only notify a customer upon departure or arrival of a parcel at a given facility. This type of tracking did not utilize GPS technology but rather was a system of barcodes and radio frequency identification (“RFID”) tags that were associated with a particular location. When GPS technology became commercially available, devices that provided location had to be hardwired inside the cab of the truck or possibly on a trailer or container. However, when a shipment was stolen, very often the truck and/or the trailer would be recovered but the cargo would not be recovered. Once the cargo was removed from the trailer, there was no way to know the location of the cargo since the GPS devices were fixed to the vehicle or container, which held the cargo until the cargo was unloaded.

For shippers, shipping container handling volumes have been increasing dramatically over the years. Such increases in handling volume are adversely affecting real-time order visibility. Each partner to the transaction needs to have access to location information throughout a container's journey. However, in port, containers are routinely not visible, which leads to a largely dependent manual count, which can routinely lead to inventory miscounts due to human error.

As GPS technology has progressed, it became possible to provide portable GPS tracking. Initially, the portable GPS trackers were extremely large, heavy, and if placed in a trailer, required a huge antenna to get GPS signals. Eventually, it was the integration of GPS and cellular technology that allowed devices small enough to truly be recognized as portable and usable when embedding the device in the cargo. An example of how a Shipper would use the portable GPS tracking devices would be to place the device inside a product box that looked like every other box on the shipment. The box would be placed on a pallet and would have an inconspicuous label that allowed the consignee to determine that was the box with a GPS tracking device inside. This allowed covert tracking of the cargo and in the event the shipment was stolen, the portable GPS tracking device stayed with the cargo in order to recover the stolen cargo, whether it was placed in another trailer, container or warehouse.

While portable GPS devices have seen continuous improvements in their size, weight, accuracy, and ability to provide additional data, the process for deploying them has not. For an organization to deploy just one device for a shipment they have two basic options, including buying a device and using a backend platform to monitor the device or renting a device from a GPS tracking company. While renting a device that you will only use once is a cheaper option, it is still relatively expensive. The user must pay for the device rental, airtime, platform, shipping to and from the GPS tracking company and emergency services. Still buying a device meant you had to pay full price for a device and you were still required to pay the additional fees.

Accordingly, in view of the problems outlined above, there exists a need for a standardized tracking device and cost effective method for simplifying the tracking and notification processes for clients while limiting tampering and further simplifying the management of the devices for the shipper.

### SUMMARY OF THE INVENTION

In accordance with one embodiment of the present invention, there is provided a method for tracking cargo for a customer including the steps of providing a tracking device to the customer, wherein the tracking device includes at least one data signaling device, a battery coupled to the at least one data signaling device for powering the at least one data signaling device, and a container surrounding a cavity, the container being sized and configured for securing the at least one data signaling device and the battery therein, and the container including a prepaid shipping label on an outer surface; providing an electronic application to the customer, the electronic application being in communication with the at least one data signaling device for monitoring the location of the tracking device, and the electronic application being configured for storing and displaying a plurality of data points relating to the tracking device; notifying the customer when one or more of the plurality of data points is equal to a preselected value; and receiving the tracking device from the customer.

### BRIEF DESCRIPTION OF THE DRAWINGS

For a fuller understanding of the nature of the present invention, reference should be made to the following detailed description, taken in conjunction with the accompanying figures in which:

FIG. 1 is a perspective view of the tracking device of the present invention in accordance with one embodiment;

FIG. 2 is an exploded view of the tracking device in accordance with the embodiment shown in FIG. 1;

FIG. 3 is a perspective view of the tracking device of the present invention in accordance with the embodiment shown in FIG. 1; and

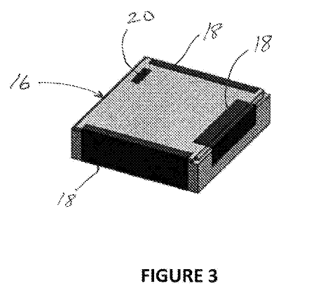

FIG. 4 is a schematic view of the electronic application associated with the tracking device of the embodiment shown in FIG. 1.

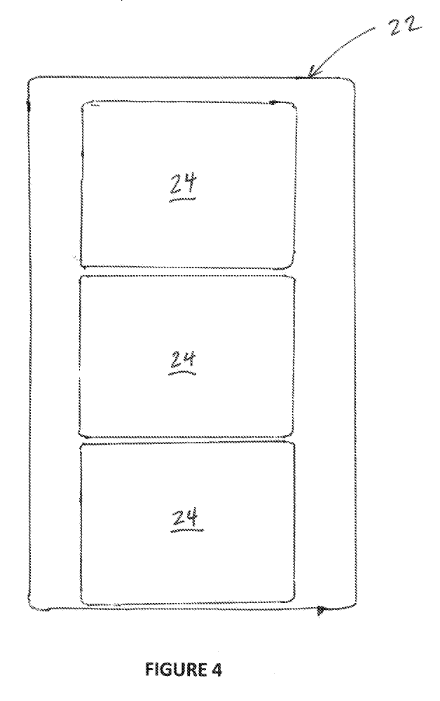

Like reference numerals refer to like parts throughout the several views of the drawings.

### DETAILED DESCRIPTION OF THE PREFERRED EMBODIMENTS

Referring to the several views of the drawings, the tracking device of the present invention for use in conjunction with parcels and packages shipped by a user or a third party is shown and described herein and is generally indicated as 10.

Note that the terms package, cargo, container and parcel may be used interchangeably herein to describe a tangible article that is shipped from a shipper to an intended recipient by use of a parcel delivery service.

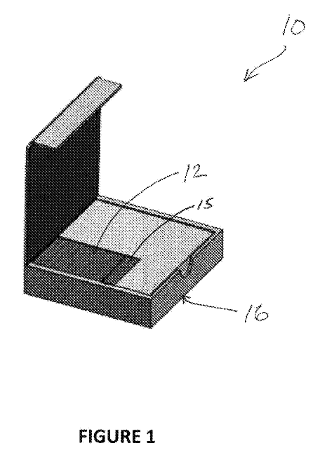

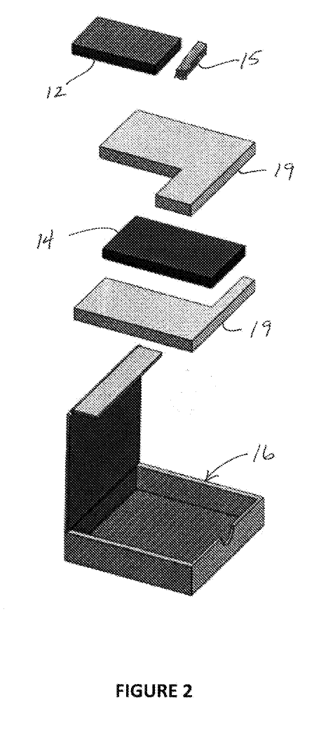

Referring to FIGS. 1 and 2, the tracking device 10 is generally provided to a user for one way and/or short-term parcel tracking. A data signaling device 12, such as tracking hardware, is structured and disposed for indicating the location of the tracking device 10 to the user. In each embodiment described herein, the data signaling device 12 may be, but is not limited to, GPS, cellular, or satellite tracking hardware. A battery 14 is included with the device 10 for powering the data signaling device 12. One or more sensors 15 are included for sensing at least one condition. The data signaling device 12, battery 14 and at least one sensor 15 are secured in an enclosed container 16 and preferably sealed with tamper evident tape 18. Packaging material 19 may be sized and configured for securely holding the data signaling device 12 and battery 14 within container 16. While tamper evident tape 18 is shown as a preferred tamper evidence indicator, other suitable indicators may be used as well.

The associated method of use generally includes providing the tracking device 10 to a user, wherein the device 10 includes data signaling device 12 and a battery 14 secured in a container 16, providing pre-paid return postage on the container 16, and refunding a portion of the associated costs upon receipt of the returned container 16.

Specifically, the method for tracking cargo for a customer including providing a tracking device 10 to the customer, wherein the tracking device 10 includes at least one data signaling device 12, a battery 14 coupled to the at least one data signaling device 12 for powering the at least one data signaling device 12, and a container 16 surrounding a cavity, the container 16 being sized and configured for securing the at least one data signaling device 12, the one or more and the battery 14 therein, and the container 16 including a prepaid shipping label 20 on an outer surface. In one embodiment, the battery 14 is a rechargeable battery. From there, the method further includes providing an electronic application 22 to the customer, the electronic application 22 being in communication with the at least one data signaling device 12 for monitoring the location of the tracking device 10, and the electronic application 22 being configured for storing and displaying a plurality of data points 24 relating to the tracking device 10; notifying the customer when one or more of the plurality of data points 24 is equal to a preselected value; and receiving the tracking device 10 from the customer.

As discussed above, in accordance with one embodiment, the data signaling device 12 is a satellite positioning tracking device. In accordance with another embodiment, the data signaling device 12 is a global positioning system (GPS) device. In accordance with yet another embodiment, the data signaling device 12 is a radio signal device provided for use in combination with one or more service providers. In each, notifications may be sent to the customer regarding movement and/or non-movement of the tracking device 10.

In one embodiment of the tracking device 10, the customer is notified at predetermined times in addition to (or instead of) when one or more of the plurality of data points 24 is equal to a preselected value. Moreover, the tracking device 10 may include at least one sensor 15. In one embodiment, the at least one sensor is a light sensor 15 wherein the container 16 is made using a transparent material and is sized for receipt of the light sensor 15, and wherein the light sensor 15 is structured and disposed for detecting the current ambient light level, which is reported as one of the plurality of data points 24.

In another embodiment of the tracking device 10, the at least one sensor 15 is a temperature sensor 15 wherein the container 16 is made from a non-insulated material and is sized for receipt of the temperature sensor 15, and wherein the temperature sensor 15 is structured and disposed for detecting the current ambient temperature, which is reported as one of the plurality of data points 24.

In another embodiment of the tracking device 10, the at least one sensor 15 is a humidity sensor 15 wherein the container 16 includes a vent and is sized for receipt of the humidity sensor 15, and wherein the humidity sensor 15 is structured and disposed for detecting the current relative humidity, which is reported as one of the plurality of data points 24.

The tracking device 10 may further include a data receiving device in communication with the data signaling device 12, the data receiving device being structured and disposed for receiving a command. In one embodiment, the command is changing the predetermined times for notifying the customer of the plurality of data points. In another embodiment, the command is turning OFF or ON one or more of the particular notifications. Moreover, where multiple tracking devices 10 are used in multi-parcel shipments, wherein a corresponding number of additional data signaling devices 12 present, the tracking devices 10 may wirelessly communicate with each other via the data receiving devices.

The electronic application 22 may be programmed with geo-fences and/or geo-routes. Moreover, the electronic application 22 can be programmed to send the plurality of data points 24 to one or more secondary contacts, such as an email account or via text message.

In each embodiment, authorized third-parties may also be designated to receive notification of one or more of the plurality of data points 24 via access of the electronic application 22 or other form of receipt (e.g., email notification).

While the present invention has been shown and described in accordance with several preferred and practical embodiments, it is recognized that departures from the instant disclosure are contemplated within the spirit and scope of the present invention.

What is claimed is:

1. A method for tracking cargo for a customer comprising the steps of:
providing a tracking device to the customer, wherein said tracking device comprises:
at least one data signaling device;
a battery coupled to said at least one data signaling device for powering said at least one data signaling device; and
a container surrounding a cavity and being operable between an open position and a closed position, said container being sized and configured for securing said at least one data signaling device and said battery therein, and said container including a prepaid shipping label on an outer surface;
providing an electronic application to the customer, said electronic application being in communication with said at least one data signaling device for monitoring the location of said tracking device, and said electronic application being configured for storing and displaying a plurality of data points relating to said tracking device;
notifying the customer when one or more of said plurality of data points is equal to a preselected value; and
receiving said tracking device from said customer.

2. The method for tracking cargo for a customer as recited in claim 1 wherein said at least one data signaling device is a satellite positioning tracking device.

3. The method for tracking cargo for a customer as recited in claim 1 wherein said at least one data signaling device is a global positioning system (GPS) device.

4. The method for tracking cargo for a customer as recited in claim 1 wherein said at least one data signaling device is a radio signal device.

5. The method for tracking cargo for a customer as recited in claim 1 wherein said battery is a rechargeable battery.

6. The method for tracking cargo for a customer as recited in claim 1 further comprising the step of notifying the customer at predetermined times.

7. The method for tracking cargo for a customer as recited in claim 1 wherein said tracking device further comprises a light sensor and said container is made using a transparent material and is sized for receipt of said light sensor, and wherein said light sensor is structured and disposed for detecting the current ambient light level.

8. The method for tracking cargo for a customer as recited in claim 7 wherein said plurality of data points includes the current ambient light level.

9. The method for tracking cargo for a customer as recited in claim 1 wherein said tracking device further comprises a temperature sensor and said container is made from a non-insulated material and is sized for receipt of said temperature sensor, and wherein said temperature sensor is structured and disposed for detecting the current ambient temperature.

10. The method for tracking cargo for a customer as recited in claim 9 wherein said plurality of data points includes the current ambient temperature.

11. The method for tracking cargo for a customer as recited in claim 9 wherein said tracking device further comprises a humidity sensor and said container includes a vent and is sized for receipt of said humidity sensor, and wherein said humidity sensor is structured and disposed for detecting the current relative humidity.

12. The method for tracking cargo for a customer as recited in claim 11 wherein said plurality of data points includes the current relative humidity.

13. The method for tracking cargo for a customer as recited in claim 6 wherein said tracking device further comprises a data receiving device in communication with said data signaling device, said data receiving device being structured and disposed for receiving a command.

14. The method for tracking cargo for a customer as recited in claim 13 wherein said command is to change the predetermined times for notifying the customer of said plurality of data points.

15. The method for tracking cargo for a customer as recited in claim 13 further comprising the step of providing one or more additional data signaling devices of said tracking devices for wirelessly communicating with each other via said data receiving device.

16. The method for tracking cargo for a customer as recited in claim 1 wherein said tracking device further comprises tamper evident tape for indicating whether said container has been opened.
